(19) United States
(12) Patent Application Publication
(10) Pub. No.: US 2022/0001343 A1
(43) Pub. Date: Jan. 6, 2022

(54) MIXING DEVICE AND METHOD OF MIXING FLUIDS

(71) Applicant: Daniel A Neverov, Alpine, CA (US)

(72) Inventor: Daniel A Neverov, Alpine, CA (US)

(21) Appl. No.: 16/920,433

(22) Filed: Jul. 3, 2020

(51) Int. Cl. B01F 7/00; B01F 13/00; B01F 3/14; B01F 3/12

(52) U.S. Cl. CPC B01F 7/00425; B01F 13/0028; B01F 2215/005; B01F 3/1221; B01F 3/14

(57) ABSTRACT

The present invention is a method of mixing various viscous fluids. The mixing device is comprised of a shroud with helical blades inside connected to the central shaft and the shroud in spiral direction. By rotating the device in the fluid or paint, helical blades create a vortex like movement of the fluid and thus create suction of the fluid through the shroud, mixing viscous fluid at a greater rate. Field test showed that the devise is very effective in mixing viscous fluids by braking solids in the paint/fluids and lifting the settlements from the bottom of a container due to the radial and axial movement of the fluid. Device was found very easy to use due to the fact that the kickback of the mixer was minimized. It also showed that the splatter of paint was almost eliminated in the open container.

### CROSS REFERENCE TO RELATED APPLICATIONS

Provisional Patent Application No. is 62/870,158, filing date Jul. 3, 2019. Filing license granted Jul. 9, 2019 Country code and number U.S. 62/870,158.

Field of invention

This present invention relates to a method of mixing paint and other various viscous fluids by rotating a helical bladed mixing device.

### BACKGROUND OF THE INVENTION

The mixing of viscous fluids is more complicated than one might think. Many methods of mixing fluids often present challenges that result in inadequate mixing, it is time consuming and much energy is used.

Probably, the most common method of mixing paint/fluid in an open container is by inserting the stir-stick and moving it in a circular direction in the container. Because of this, individuals often stop mixing long before the paint/fluid is thoroughly mixed. Further, even if a person mixes with a stirring stick for a long time there is no guarantee that the paint/fluid is adequately mixed, rather than simply moved around the container. Many mechanical mixers were made to eliminate the manual labor and to improve the mixing process.

In prior art U.S. Pat. No. 3,733,645 by Mr. Seiler it discloses a paint mixer with a star shaped attachment. This apparatus is not effective as it is driven by the drill in the paint. It will mix paint at a very slow rate as it moves paint/fluid in a circular motion around the device. It will not break the solids in the paint and will not lift the settlements from the bottom of the container.

### BRIEF SUMMARY OF THE INVENTION

The present invention is a method of mixing various viscous fluids. The method is placing a mixing device in a container of fluid and rotating said device in said fluid with an electric drill or air powered mechanism. The mixing device is comprised of a shroud with helical vanes/blades inside connected to the shaft and the shroud.

The shaft is elongated, with the helical vanes/blades connected to it on the outside of the shaft in a helical manner. The shroud is placed over the helical blades and is connected to the blades.

The helical blades are placed on the circumference of the central shaft in a spiral direction and connected to the inner side of the circumference of the shroud in spiral direction. The helical blades are extending from one end of the shroud to the other according to the length of the shroud.

Helical blades have a revolution of 120 degrees from one opening of the shroud to the other opening. By rotating the device in the fluid or paint, helical blades creating a vortex like movement of the fluid and thus creating suction of the fluid through the shroud, mixing a viscous paint or a fluid at a greater rate. Field test showed that the devise is very effective in mixing viscous paint by braking solids in a paint and lifting the settlements from the bottom of a container. Device was found very easy to use due to the fact that the kickback of the mixer is very small, it also showed that the splatter of paint is almost eliminated in the open container.

The advantage of the present invention will be more apparent in the following detailed descriptions of the drawings.

### BRIEF DESCRIPTION OF THE DRAWINGS

FIG. 1 is a perspective view of a mixing device for use in the method of present invention.

FIG. 2 is an angled front view of the present invention

FIG. 3 is an enlarged opaque view of the device that shows inside of the shroud of the present invention.

FIG. 4 is a view of the device inside of a container with paint/fluid showing a flow and a direction of the fluid.

FIG. 5 is a view of the device with a hex shape housing for attaching shaft to the said device.

### DETAILED DESCRIPTION OF THE PRESENT INVENTION

The present invention is an improvement of a method to mix the fluid/paint in a container, by rotating a new and an improved rotary device.

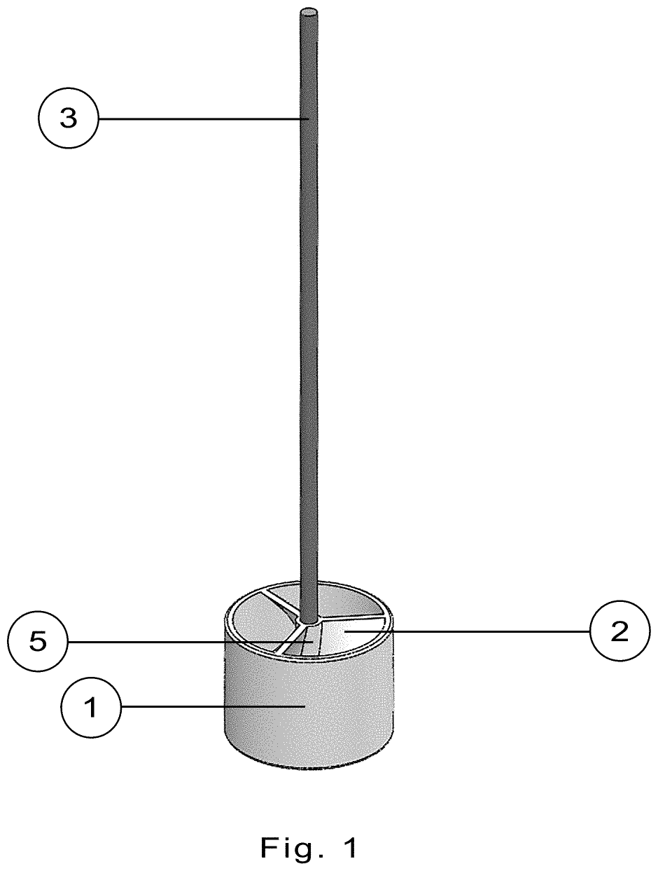

The following are the components of the Mixing Device, which are shown in FIG. 1 through FIG. 4 drawings:
1. One elongated shaft (3) of said device. This elongated shaft can be inserted into the central shaft and/or attached.
2. One cylindrical shroud (1) of said device.
3. At least one helical blade (2). In the FIG. 1 through FIG. 5 are shown three helical blades (2). However more helical blades can be inserted between the shroud and the shaft.
4. One central shaft (5) with round or hex housing for attaching said device to the elongated shaft (3).
5. A method of mixing fluids containing the helical blades (2) with cylindrical shroud (1).

FIG. 1 Shows general view of the device, new device consists of a shroud (1). And helical blades (2). That are attached to the shroud (1). And placed inside the shroud (1). The helical blades (2) are attached to the central shaft (5). The central shaft (5) is a housing for a shaft (3) that is connected to a rotary device such as an electric or an air powered drill. Shroud (1) is a tube like device that has open ends and is placed over helical blades (2) and is attached or welded on to the helical blades (2). The shroud (1) could be made out of a verity of materials such as hard flexible plastic, carbon fiber, stainless steel or any other metal or a composite material depending on the application. The helical blades (2) can be made of the same materials as the shroud (1). The helical blades (2) are inside of the shroud (1) and are arranged in a helical or spiral direction. The helical blades (2) are extending from one opening end of the shroud (1) to another end and flash with the shroud (1) on both ends. The shaft (3) could be made out of metal or another composite material and can be ¼ of an inch in diameter for most applications or larger and can be in length of 12″ for a gallon size container and 18″ for a five gallon container and can be made a larger size in diameter and in length for larger containers. The whole device can be machined or 3D printed or could be made by using injection mold process.

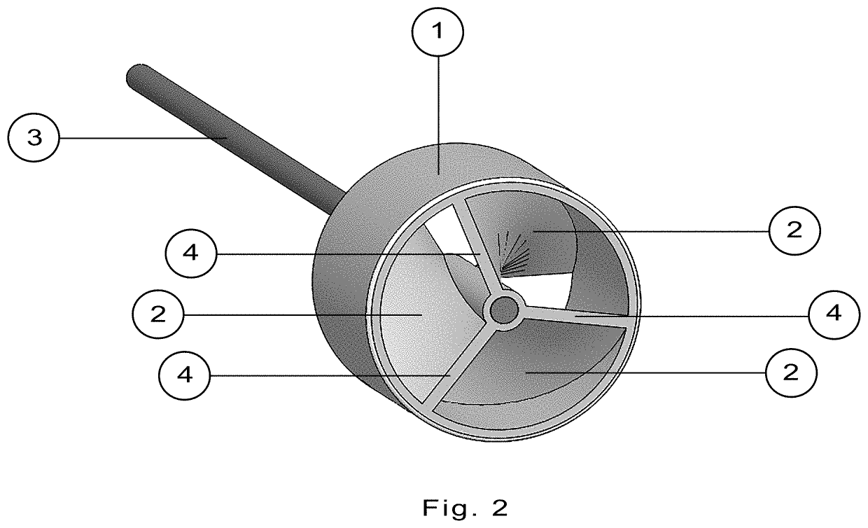

FIG. 2 is an angled view of the device. FIG. 2 shows that the shroud (1) has two open ends through which the fluid goes through in a mixing process. The front (4) of the blades (2) is flash with the front of the shroud (1), the front (4) of the blade (2) can function as scrapers of settlements in a paint container. The helical blades (2) have one revolution from the front of the shroud (1) to the back end opening of 120 degrees. Field test showed that the 120 degree pitch is the most effective pitch and sufficient to mix most fluids in a container. But it is not limited to other sizes, angles and pitch direction. The blade fronts (4) point to the center of the shaft in the front of the shroud (1) continuously through the pitch of the blade (2).

Shaft (3) serves as the means of attaching the device to the rotary. FIG. 2 shows three helical blades (2) formation, other formations would be suitable for other applications, formation of more helical blades (2) can be used. Helical blades (2) are spaced 120 degrees apart from each.

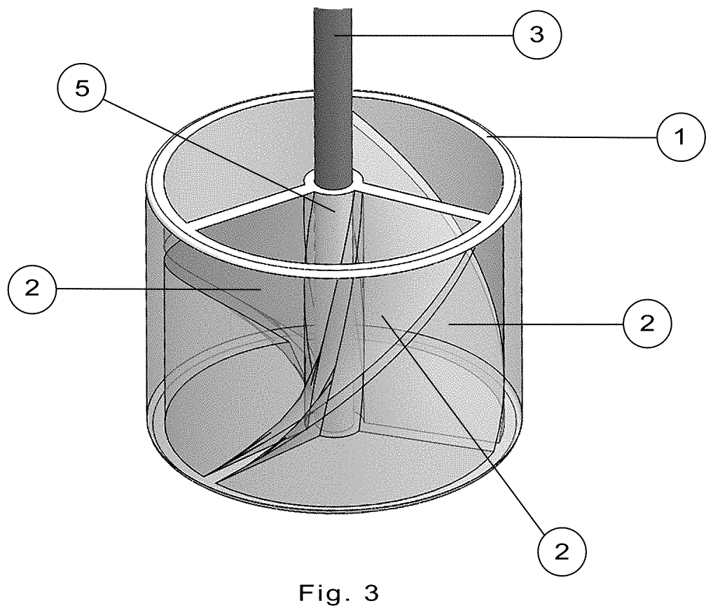

FIG. 3 is an opaque view of the embodiment. FIG. 3 has vivid direction of the blades (2) inside the shroud (1).The helical blades (2) are attached to the inner wall of the shroud (1) and are attached to the center shaft (5). The helical blades (2), shown here at 120 degree direction imitates the natural flow of fluids, thus, reducing the kick back of the central shaft (3) in an apparitional mode and imparts faster ratio of mixing of any fluid.

The shroud (1) having a tubular form and placed over the helical blades (2), in an operation mode of the device, helical blades (2) impart a suction of the fluid through the shroud (1) in a vortex rotation. Central shaft (5) has a tubular shape and has an opening in the center for an attachment of the shaft (3). The shaft (3) fits in to an opening of the central shaft (5) from the back end all the way through to the front end of the central shaft or can be partially inserted into the housing of the central shaft (5).

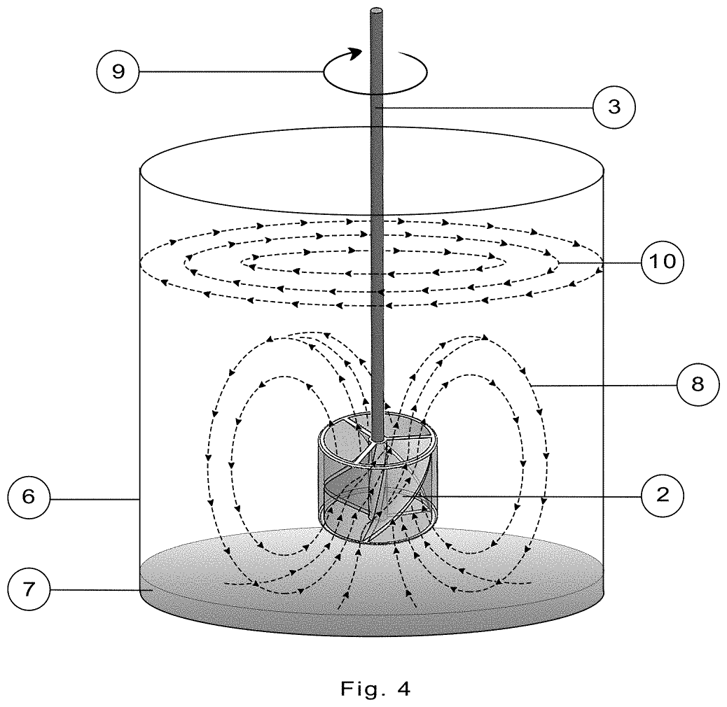

FIG. 4 shows the mixing device in a container (6) and its function in the fluid while in operation. The shaft (3) is connected to a rotary device to rotate the mixing device in a fluid. The arrow (9) shows the direction of the rotation of the shaft (3). Rotation can be used in the reverse direction if desired. Number (7) shows a settlement of solids in the paint or any other fluid. The arrows (8) are showing the direction of paint or other fluids in-through and out of said device. In FIG. 4 said device is rotating in a clockwise direction thus creating movement of paint or fluids from the bottom of a container (6) to the top of the container. The helical blades (2) are creating vortex suction effect in the shroud (1) thus lifting the settlements (7) and moving them to the top of said container mixing the fluid at a rapid rate. The mixing device imparts two movements to the fluid, one is shown by the arrows (8) through the said device and all around and about shown by arrows (10) in the said container (6) thus mixing the fluid at a faster rate. Movement shown at the top of the fluid with arrows (10) is a movement of fluid around and about the said container (6).

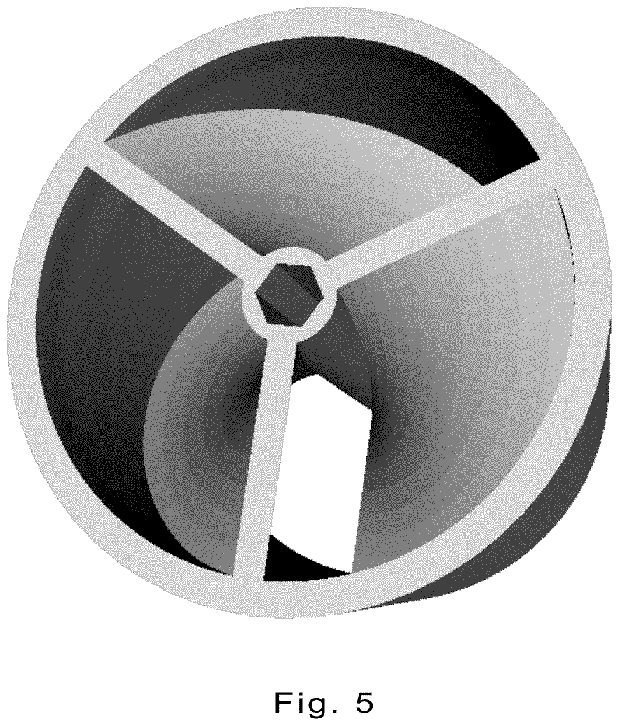

FIG. 5 The same device with a hex shape housing for the shaft.

1. The improvements of the said device are—faster, thorough and at a greater rate of mixing fluids. Due to the design of the helical blades placed inside the shroud, the mixer can mix the fluids in two combined methods of mixing, radial and axial, simultaneously. The design and placement of the shroud over the blades creates a jet like mixing effect and serves as elimination of kick-back of the mixer during the mixing process. The combination of the shroud and the helical blades internally positioned between the shroud and the central shaft create an improved mixing method of fluids:
1. Reduction in RPM, splatter and oxidation of the fluids.
2. Decreasing the kick-back of the mixer during the process of mixing.
3. Creating radial and axial mixing simultaneously, thus mixing solids and resins in fluids at a greater rate.
